(19) United States
(12) Patent Application Publication
(10) Pub. No.: US 2005/0175802 A1
(43) Pub. Date: Aug. 11, 2005

(54) Packaging surface element with non-adhesive coating and packaging surface with non-adhesive coating

(76) Inventors: Hubert Kaffl, Fischbachau (DE); Jan Gerrit Hendrik Tempelman, Goor (NL)

Correspondence Address: FROMMER LAWRENCE & HAUG, 745 FIFTH AVENUE- 10TH FL., NEW YORK, NY, 10151, US

(21) Appl. No.: 10/650,018

(22) Filed: Aug. 27, 2003

Related U.S. Application Data
(63) Continuation-in-part of application No. 10/392,314, filed on Mar. 19, 2003, now abandoned.

(30) Foreign Application Priority Data
Mar. 20, 2002 (DE) DE 202 04 432.7

(51) Int. Cl. F16L 1/00

(52) U.S. Cl. 428/35.7

(57) ABSTRACT

The invention relates to a packaging surface element with a non-adhesive coating for an adhesive article or an article containing an adhesive means, as well as a packaging surface with a non-adhesive coating.

The invention relates to a packaging surface unit or a flat packaging element for adhesive goods or goods that contain an adhesive means or is provided with adhesive means.

It is known to manufacture a pouch for receiving solid goods, such that one binds surfaces of a plastic material to one another along a seam, for example, by heat sealing. The plastic material can exist in the form of a packaging surface unit, which is to be folded in the center, so that both halves cover one another. For making a pouch, also two packaging pieces can be provided, which form the two pouch walls. The plastic material has a coating on the side(s) to be sealed made of a heat-sealable material, for example, from polyethylene, polypropylene, Surlyn, or another material. With the use of temperatures of 140° C., for example, the coated sides are bound to one another.

However, all pressure-sealable, adhesive, or heat-sealable materials have the characteristic of adhering very strongly on pressure-sensitive points. This has the result that they also occasionally bind with the goods to be packaged that contain an adhesive means. This is true, in particular, when the goods to be packaged are self-adhesive labels, bandages, or transdermal systems, which are provided with a protective layer over its adhesive layer. They have the common problem that on their edges, which are cut or stamped, adhesive materials or an adhesive, which generally is a pressure-sensitive adhesive, can escape when stored. Depending on the storage conditions, with the consumer or, even with the manufacturer, the adhesive leak can lead to an adhesion of the goods to be packaged with the packaging.

Many bandages, transdermal systems, or labels are provided with a packaging protecting it from environmental effects. Generally, deep-drawn films serve as the packaging, into which the products can be inserted. Subsequently, they are closed with a further film. In the closed packaging means, the product generally is freely moveable, so that the danger of the adhesion of the product with the packaging means is not so great. Much greater, however, is the danger if a pocket or pouch is selected as the packaging means. The product is then exposed to an intensive contact with the pouch inner surface, in particular, when stacked. This leads to an adhesion of the goods to be packaged with the packaging means under certain circumstances or regularly. When the product is removed from the packaging means, this leads to difficulties, whereby in certain cases, the entire product is destroyed.

From the state of the art, solutions are known, in which, respectively, a separating sheet is placed on the products. Or bumps are provided on a protective film, which is adhered to the product, which can be higher than the thickness of the product, in order to reduce the contact with the pouch material; compare, for example, DE 19 902 196, EP 0 405 393 and further, WO 89/04 158, U.S. Pat. No. 2,577,945, U.S. Pat. No. 3,068,860, and U.S. Pat. No. 4,498,586.

The known features have the disadvantage that they are technically expensive and the consumer must either ruin an additional material or the product must be applied on an unnecessarily large protective film. In this regard, each pouch can accommodate far fewer products. In addition, the binding of the product with the protective foil has an inelegant appearance.

It is the object of the present invention to produce a remedy for the above problem.

According to the present invention, this object is solved with a packaging means or packaging surface element (1) for adhesive goods (6) or goods containing adhesive means, wherein the packaging surface element (1) has a non-adhesive coating (11, 12) at least partially or in areas or zones on the inner side of its wall or on its inner wall (2, 3).

The non-adhesive coating effectively prevents an adhesion of any adhesive material and, thus, in particular, also the adhesion, for example, of labels, bandages, and transdermal systems. In this regard, it has the particular advantage that it can be applied lightly, and thus, does not reduce the space for the goods to be packaged within the packaging means or packaging surface element. The non-adhesive coating is a fixed component of the packaging means and, accordingly, need not be removed first by the consumer or user.

Advantageous further embodiments are provided in the dependent claims and in the description.

The non-adhesive coating (11, 12) of the packaging surface element according to the invention can be applied proximate to the goods (6) to be packaged on or above a sealable coating (4, 5) on the inner wall (2, 3). The non-adhesive coating (11, 12) covers surfaces that are not to be sealed.

Further, the sealable coating (4, 5) of the packaging surface element according to the invention can be a pressure-sealable or heat-sealable coating.

The sealable coating can carry the non-adhesive coating. In this manner, the sealing of surfaces is not affected, in order to make pouches or other closed packaging elements. In addition, only material for the non-adhesive coating is used where it is necessary to prevent adhesion of the packaging goods.

Further, the sealable coating (4, 5) of the packaging surface element according to the invention can be a polymer material comprising a proportion of not-fully reacted starting material which reacts fully upon sealing.

Further, the sealable coating (4, 5) of the packaging surface element according to the invention can be a combination of a sealable material and a non-adhesive agent (abherent). This means that the packaging surface element can be sealed as if it were not mixed with a non-adhesive agent, and that the non-adhesive agent provides its non-adhesive effect where the packaging surface element has not been subjected to a sealing.

Further, the combination of a sealable material and a non-adhesive agent can be provided as admixture or as a flat design.

Further, the sealable material of the packaging surface element according to the invention and packaging surface element according to the invention can be a heat-sealable material, preferably polyethylene.

Further, the non-adhesive coating (4, 5) of the packaging surface element according to the invention can be applied on the inner side of the wall (2, 3) between surfaces to be sealed.

In this manner, also the material for making the surfaces to be sealed is used sparingly.

Further, the non-adhesive coating of the packaging surface element according to the invention can be applied between surfaces to be pressure-sealed or heat-sealed.

Further, the non-adhesive coating (11, 12) of the packaging surface element according to the invention can be based on silicone or polysiloxane, preferably polydimethyl siloxane (PDMS) or metal, preferably a metal vapor deposition.

Further, the non-adhesive coating (11, 12) of the packaging surface element according to the invention can be based on at least one halogenated hydrocarbon polymer.

Further, the problem underlying the invention is solved by a packaged transdermal system (21), wherein the system comprises
a transdermal system (22) comprising a supporting layer (23), a matrix (24) and a removable covering layer (25), wherein the covering layer (25) is a non-adhesive layer and is at least at its periphery or circumference (26) sealable, and
a packaging surface element (27) which is provided with a non-adhesive coating on its inner wall and is sealable at least at its periphery or circumference (28),
wherein the transdermal system (22) and the packaging surface element (27) are sealed with each other at least at their circumferences (26, 28).

The matrix of the system according to the invention can be selected from the group consisting of a self-adhesive matrix and a matrix provided with an adhesive.

Further, the packaging surface element of the packaged transdermal system according to the invention can be an element according to the invention as described above.

Further, the problem underlying the invention is solved by a packaged transdermal system (32), wherein the system comprises a supporting layer (33), a matrix (34) and a removable covering layer (35), wherein the covering layer (35) is a non-adhesive layer, extends circumferentially beyond the matrix (34) to such an extend that it can be folded such that one wing (36) of the folded covering layer (35) carries the matrix (34) with supporting layer (33) and the other wing (37) covers the first wing (36), and wherein the covering layer (35) is at least at the edge (28) of its circumference sealable.

The matrix (34) of the system according to the invention can be selected from the group consisting of a self-adhesive matrix and a matrix provided with an adhesive.

Further, the problem underlying the invention is solved by a packaging surface (14) comprising packaging surface elements (1) according to the invention, wherein the sequence, distances or spacings of the non-adhesive coatings (11, 12) are marked by recurring reference points or recurring markings or recurring marks (15).

In this connection, the present invention also addresses the object of forming the packaging surface, such that it can be easily depackaged from the packaging surface elements made from it.

The recurring marks of the packaging surface according to the invention can be registration marks or pressure marks.

Further, the pressure marks (15) of the packaging surface (14) according to the invention can be periodic, recurring marks spaced in accordance with the sequence of packaging surface elements (1) to be sealed, or wherein the distance of neighbouring periodic, recurring marks corresponds to a packaging surface element (1) to be sealed.

Finally, the marks (15) of the packaging surface according to the invention can be punched marks or color marks or dye marks.

The non-adhesive coating and/or the pressure- or control marks can be imprinted, whereby rotogravure is preferred, since it offers a satisfactory accuracy.

Next, the invention will be described more specifically with reference to the drawings. In the drawings:

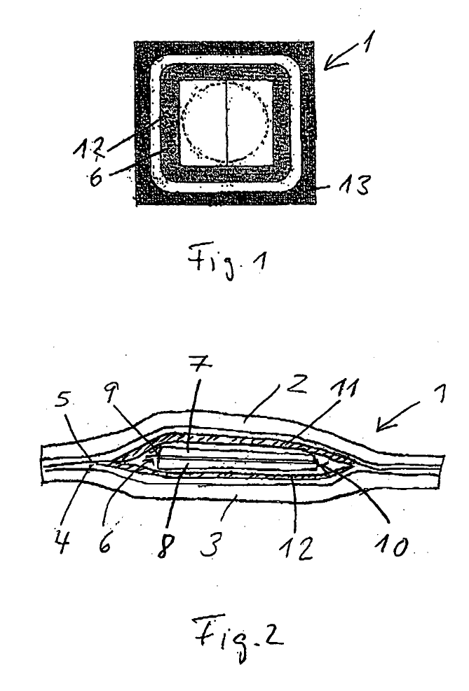

FIG. 1 shows a plan view of a lower packaging surface element for a sealed pouch with a transdermal system applied thereon;

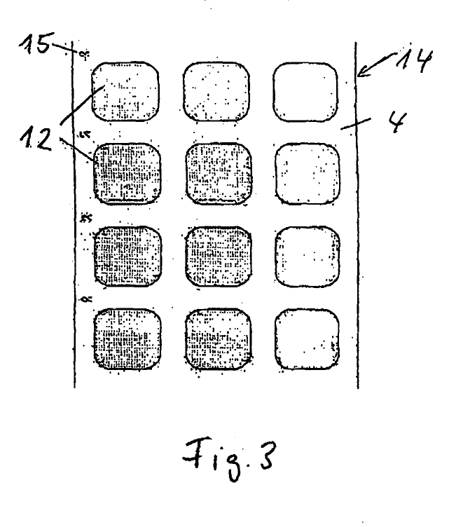

FIG. 2 shows the sealed pouch with the transdermal system according to FIG. 1 in cross section;

FIG. 3 shows a packaging material with a plurality of non-adhesive coatings in plan view.

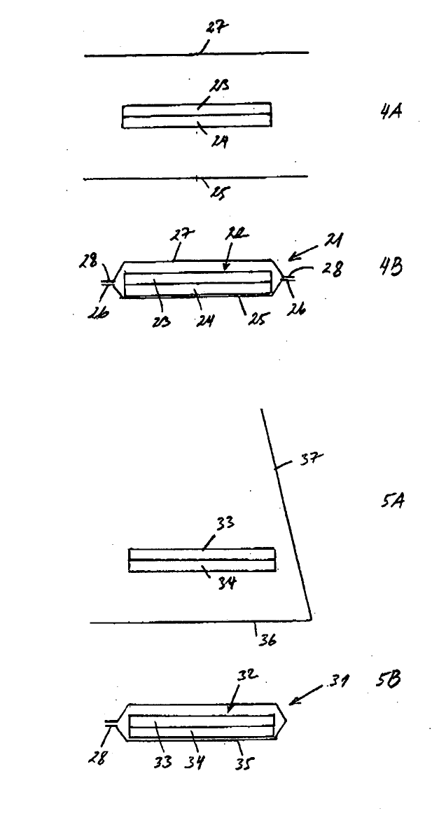

FIG. 4a shows a transdermal system, a covering layer for the transdermal system and a packaging surface element:

FIG. 4b shows the transdermal system according to FIG. 4a packaged with the covering layer and the packaging surface element;

FIG. 5a shows a transdermal system and a covering layer for the transdermal system; and

FIG. 5b shows the transdermal system according to FIG. 5a packaged with the covering layer.

A sealed pouch 1 (FIGS. 1, 2) comprises two packaging surface elements connected to one another with their inner sides and has two opposite walls 2, 3, which, respectively, carry a heat-sealable material 4, 5 on their inner sides. The walls 2, 3, comprise a packaging material, for example, paper or cardboard. The coatings 4, 5 contain or comprise, for example, polyethylene, polypropylene, or other heat-sealable materials. With the use of pressure or increased temperatures, for example, in the range of 140° C., the coatings 4, 5, can be connected fixedly to one another, in order to enclose a transdermal system 6 or another type of goods.

The possibility is not excluded that the coatings 4, 5, when they have a sufficient thickness, already form the pouch walls themselves, so that separate walls 2, 3 as the support for the coatings 4, 5 are not required.

The transdermal system 6, which is provided for application to human skin, can have a layer 7 containing an active component and a peelable layer 8, which are connected to one another by an adhesive layer. The layer 7 is provided with a cover layer (not shown). On transverse sides 9, 10 of the transdermal system 6, in disadvantageous cases, adhesive leaks from the adhesive layer, which could adhere with the coatings 4, 5. In order to prevent this kind of adhesion, each of the coatings 4, 5 is provided on its inner side of the sealed pouche 1 with a non-adhesive coating 11, 12. This contains, for example, silicone or a halogenated hydrocarbon.

The coatings 11, 12 can be formed by any layer that can be bound to the coatings 4, 5, which has the characteristic that the adhesion of the goods packaged in the sealed pouch, in the present case, the transdermal system 6, based on the adhesive leaking to the transverse sides 9, 10, is prevented.

The coatings 11, 12 are only applied in the inner region of the sealed pouch 1 on the coatings 4, 5, so that the coatings 4, 5, can combine for forming a circumferential sealing seal that encloses the transdermal system 6.

In an alternative embodiment of the present invention, the coatings 11, 12 are directly applied to the walls 2, 3 of the sealed pouch 1 itself, while the coatings 4, 5, are only applied in the area of the sealing seam 13. In this manner, a heat-sealable material can be spared.

The non-abrasive coating 11 or 12 can be positioned by means of a pressure- or a adhesion method on the inner side of a packing material, that is, for example, of a sheet or a film 14 (FIG. 3), which forms, for example, the packaging material. The manufacturing method is selected, such that the positionings of the coating 12 are exactly determined, and that the sealable coating 4 is not covered in the region of the sealing seam 13 by the coating 12, when the film 14 is sealed at a later stage for making sealed pouches 1.

For achieving exact positions, the film 14 has marks, for example, pressure marks 15, which are applied either on the side facing away from the coating 4 or on the side of the coating 4 itself. As pressure marks 15, color or dye marks are particularly suitable, whose spacing in the longitudinal direction of the processing of the film 14 is as large as the length of a sealed pouch 1.

The pressure- or lacquering work of a pressure machine, with which the coating 12 should be applied, can be positioned precisely, based on the pressure marks 15. The packaging machine, used in a subsequent procedure, with which the sealed pouched 1 is sealed from the film 14, finds the positions of the coating 12 again, when it is equipped with appropriate detectors, based on the pressure marks 15 and then performs the sealing.

FIG. 4a shows a transdermal system 22, which is composed of or comprises a supporting layer 23 which carries a matrix 24. This transdermal system 22 is to packaged with a covering layer 25 and a packaging surface element 27. As regards removable covering layers 25, reference can be made to the art of transdermal systems, size and shape of the covering layer 25 and the packaging surface element 27 can correspond to each other. They are provided in such a shape and size that they can form the shells of a housing for the transdermal system. The covering layer 25 and the packaging surface element 27 are sealable with each other at least at their circumference 26, 28.

The matrix 24 can be a self-adhesive matrix or a matrix carrying an adhesive so that the covering layer 25 adheres to the matrix 24. Upon use of the packaged transdermal system 21, the housing of the transdermal system formed by the covering layer 25 and the packaging surface element 27 will be removed. The covering layer 25 will be torn off the transdermal system 22 as usual. Since the packaging surface element carries a non-adhesive coating on its inner wall, it does not adhere on the supporting layer 23 of the transdermal system 22.

FIG. 5a shows a transdermal system 32 comprising or consisting of a supporting layer 33 which carries a matrix 34. The transdermal system 32 is to be packaged with a covering layer 35. The matrix 34 of the transdermal system 32 can be self-adhesive or carry an adhesive. Thus, the covering layer 35 will stick to the transdermal system 32 only with its matrix 34 and not with its supporting layer 33. Before packaging the transdermal system 32 with the covering layer 35, the covering layer 35 is folded in such a manner that two wings or halves 36, 37 are formed. Preferably both wings 36, 37 of the covering layer 35 correspond to each other as regards size and shape.

FIG. 5b shows the packaged transdermal system 32 in a housing formed by the two wings 36, 37 of the covering layer 35. The covering layer 35 is at least at the edge 28 of its circumference sealable so that the housing of the transdermal system 32 can be completely closed. It goes without saying that the wing 37 of the covering layer 35 vis-à-vis the supporting layer 33 does not adhere on the supporting layer 33, and that only wing 36 of the covering layer 35 adheres on the matrix 34. Upon use of the packaged transdermal system 31, the covering layer 35 can easily be torn off.

The sealed edges of the circumference 26, 28 of the covering layer 25 and the packaging surface element 27 of the transdermal system 21 according to FIGS. 4a and 4b and the sealed edge 28 of the circumference of the covering layer 35 of the transdermal system 31 according to FIGS. 5a and 5b can be provided with punchings so that they can easily torn.

### REFERENCE NUMERAL LIST

1 sealed pouch
2 wall of the pouch
3 wall of the pouch
4 sealable coating
5 sealable coating
6 transdermal system
7 layer with active component
8 peelable layer
9 transverse side
10 transverse side
11 non-adhesive coating
12 non-adhesive coating
13 sealed layer, for example, 5 or 2 with 5
14 film
15 markings or pressure marks
16 -
17 -
18 -
19 -
20 -
21 transdermal system packaged
22 transdermal system unpackaged
23 supporing layer
24 matrix
25 covering layer
26 circumference of covering layer
27 packaging surface element
28 circumference of packaging surface element
29 -
30 -
31 transdermal system packaged
32 transdermal system composed of supporting layer and matrix
33 supporting layer
34 matrix
35 covering layer
36 wing of folded covering layer
37 wing of folded covering layer

1. A packaging surface element (1) for adhesive goods (6) or goods containing adhesive means, wherein the packaging surface element (1) has a non-adhesive coating (11, 12) at least partially on its inner wall (2, 3).

2. The packaging surface element according to claim 1, wherein the non-adhesive coating (11, 12) is applied proximate to the goods (6) to be packaged on or above a sealable coating (4, 5) on the inner wall (2, 3), and wherein the non-adhesive coating (11, 12) covers surfaces that are not to be sealed.

3. The packaging surface element according to claim 2, wherein the sealable coating (4, 5) is a pressure-sealable or heat-sealable coating.

4. The packaging surface element according to claim 1, wherein the sealable coating (4, 5) is a polymer material comprising a proportion of not-fully reacted starting material which reacts fully upon sealing.

5. The packaging surface element according to claim 1, wherein the sealable coating (4, 5) is a combination of a sealable material and a non-adhesive agent (abherent).

6. The packaging surface element according to claim 5, wherein the combination is provided as admixture or as a flat design.

7. The packaging surface element according to claim 5, wherein the sealable material is a heat-sealable material, preferably polyethylene and the non-adhesive material is silicone or polydimethyl siloxane PDMS.

8. The packaging surface element according to claim 1, wherein the non-adhesive coating (4, 5) is applied on the inner side wall (2, 3) between surfaces to be sealed.

9. The packaging surface element according to claim 8, wherein the non-adhesive coating is applied between surfaces to be pressure-sealed or heat-sealed.

10. The packaging surface element according to claim 1, wherein the non-adhesive coating (11, 12) is based on silicone or polysiloxane, preferably polydimethyl siloxane (PDMS), or metal, preferably a metal vapour deposition.

11. The packaging surface element according to claim 1, wherein the non-adhesive coating (11, 12) is based on at least one halogenated hydrocarbon polymer.

12. A packaged transdermal system (21), wherein the system comprises
a transdermal system (22) comprising a supporting layer (23), a matrix (24) and a removable covering layer (25), wherein the covering layer (25) is a non-adhesive layer and is at least at its circumference (26) sealable, and
a packaging surface element (27) which is provided with a non-adhesive coating on its inner wall and is sealable at least at its circumference (28),
wherein the transdermal system (22) and the packaging surface element (27) are sealed with each other at least at their circumferences (26, 28).

13. The system according to claim 12, wherein the matrix (24) is selected from the group consisting of a self-adhesive matrix and a matrix provided with an adhesive.

14. (canceled)

15. A packaged transdermal system (31), wherein the system comprises a supporting layer (33), a matrix (34) and a removable covering layer (35), wherein the covering layer (35) is a non-adhesive layer, extends circumferentially beyond the matrix (34) to such an extend that it can be folded such that one wing (36) of the folded covering layer (35) carries the matrix (34) with supporting layer (33) and the other wing (37) covers the first wing (36), and wherein the covering layer (35) is at least at the edge (28) of its circumference sealable.

16. The system according to claim 15, wherein the matrix (34) is selected from the group consisting of a self-adhesive matrix and a matrix provided with an adhesive.

17. A packaging surface (14) with packaging surface elements (1) according to claim 1, wherein the spacings of the non-adhesive coatings (11, 12) are marked by recurring marks (15).

18. The packaging surface according to claim 17, wherein the recurring marks are registration marks or pressure marks.

19. The packaging surface according to claim 17, wherein the pressure marks (15) are periodic, recurring marks spaced in accordance with the sequence of packaging surface elements (1) to be sealed, or wherein the distance of neighbouring periodic, recurring marks corresponds to a packaging surface element (1) to be sealed.

20. The packaging surface according to claim 17, wherein the marks (15) are punched marks or color marks.
